(19) United States
(12) Patent Application Publication
(10) Pub. No.: US 2009/0013292 A1
(43) Pub. Date: Jan. 8, 2009

(54) CONTEXT DEPENDENT TIMING ANALYSIS AND PREDICTION

(75) Inventor: Jean-Marie Brunet, San Jose, CA (US)

Correspondence Address: Trellis Intellectual Property Law Group, PC, 1900 EMBARCADERO ROAD, SUITE 109, PALO ALTO, CA, 94303, US

(73) Assignee: MENTOR GRAPHICS CORPORATION, Wilsonville, OR (US)

(21) Appl. No.: 11/773,390

(22) Filed: Jul. 3, 2007

(51) Int. Cl. G06F 17/50

(52) U.S. Cl. 716/6

(57) ABSTRACT

In one embodiment, a method for providing a context aware timing analysis is provided. A library of cells is pre-computed to take into account contouring that may result based on possible context situations for instances in an integrated circuit design. This results in a library that includes a characterization for each of the plurality of context situations. The timing analysis may then be run after pre-computing the library based on the context situations. The context situation for instances in the integrated circuit design are determined. Then a characterization for the instances based on the context situation is determined from the pre-computed library of characterizations. Because the characterization for the context situations was pre-computed based on possible combinations of context situations that may be found in the design, a lookup of the characterized timing information may be performed. Thus, a re-characterization during runtime does not need to be performed.

### BACKGROUND

Particular embodiments generally relate to fabrication of integrated circuits and more particularly to timing analysis for a layout of an integrated circuit design based on context situations.

In the design and manufacture of integrated circuits, analysis tools may be used to determine whether the functioning of the chip for the integrated circuit design will be correct before manufacturing the chip. One analysis includes a timing analysis, which may be a static timing analysis or spice simulation. The timing analysis verifies the timing at which different signals pass through various portions of a device to ensure that the device operates as planned. For example, the timing analysis verifies that signals reach their destination at a proper time or within a proper time window.

The timing analysis uses current flows that are based on drawn data from the integrated circuit layout. These drawn dimensions are typically rectangular polygons, with straight lines and sharp corners. In sub-65 nanometer or other comparable designs, where the desired IC features are generally smaller than the wavelength of the light used for lithographic patterning, the layout does not print as drawn. Corners become rounded, line ends pull back, line widths change, and straight lines can now have ripples. As changes to the critical dimensions of features in a cell are introduced, the timing analysis may be affected. To determine the effects of changes in the feature shapes, which we will generally call “contouring,” a context of surrounding cells for a cell being tested needs to be determined. The contouring that may result may differ depending on where the cell is situated in the integrated circuit layout. For example, the density of features in the neighboring cells may affect the contouring that may result.

A timing file includes electrical properties of the instances that compose the design. This timing file needs to be characterized based on the contouring that may result. The characterization may be different depending on the different context situations that occur. The characterization is computationally extensive and it may not be feasible to perform at run time during the timing analysis. For example, when full chip timing verification is performed on very large-scale integrated (VLSI) circuits, the timing analysis may be very time consuming if characterization is performed during runtime, especially when many different context situations occur. Further, a conventional timing analysis flow does not include a characterization step during the analysis. Thus, timing analysis tools must be redesigned to perform the characterization during run time, which may be undesirable.

### SUMMARY

In one embodiment, a method for providing a context dependent analysis and timing prediction is provided. A library of cells is pre-computed to take into account contouring that may result based on possible context situations for instances in a layout (or portion thereof) an integrated circuit design. Timing information in a timing file (e.g., a .lib file) may be characterized based on the context situations for the instances. Thus, in one embodiment, the timing information for each instance is characterized for each context situation that may result. This results in a library that includes a characterization for each of the plurality of context situations.

The timing analysis may then be run after pre-computing the library based on the context situations. The context situation for instances in the integrated circuit design are first determined. Then a characterization of timing information for the instances based on the context situation is determined from the pre-computed library of characterizations. Because the characterization for the context situations was pre-computed based on possible combinations of context situations that may be found in the design, a lookup of the characterized timing information may be performed. Thus, a re-characterization during runtime does not need to be performed. For example, a characterized timing file for the context situation is retrieved and used in the timing analysis.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a process for performing a timing analysis according to one embodiment.

FIG. 2 shows an example of a layout for an integrated circuit design that shows where timing can be measured according to one embodiment.

FIG. 3 depicts a simplified flowchart of a method for determining the timing information according to one embodiment.

FIG. 4 depicts an example of a cell according to one embodiment.

FIG. 5 shows an example of a place and route for an integrated circuit design 500 according to one embodiment.

FIG. 6 depicts a simplified flowchart of a method for performing the pre-computation according to one embodiment.

FIG. 7 shows a distribution for context parameters for four parameters according to one embodiment.

FIG. 8 depicts a simplified flowchart of a method for determining a subset of the library for a timing analysis according to one embodiment.

FIG. 9 shows the example of a context situation that can be determined.

FIG. 10 depicts a simplified flowchart of a method of optimizing the pre-computation according to one embodiment.

FIG. 11 shows a possible distribution for a context parameter.

### DETAILED DESCRIPTION OF EMBODIMENTS

### General Timing Analysis Overview

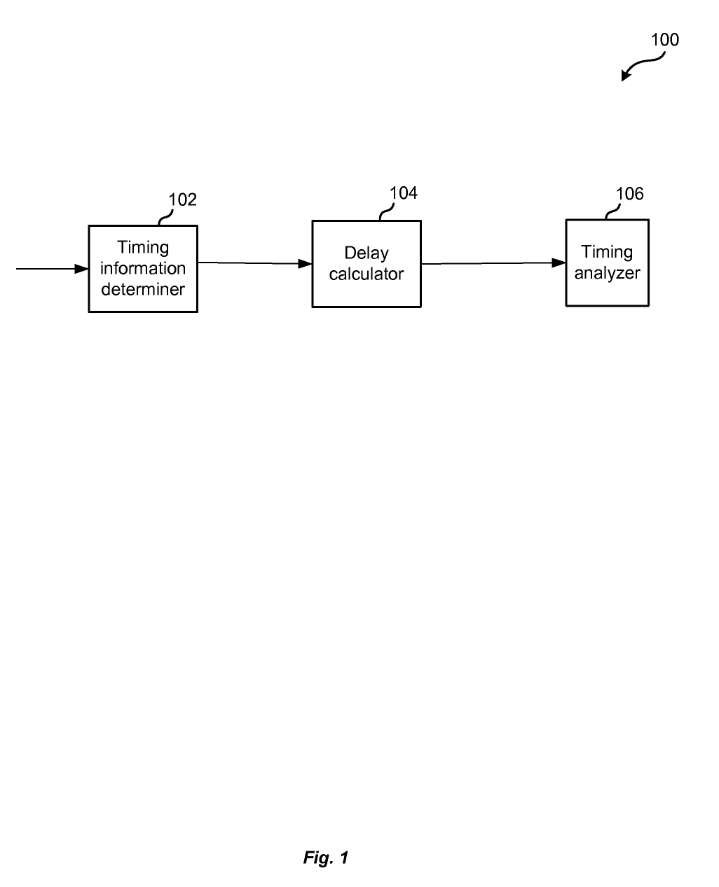

FIG. 1 depicts an example of a process for performing a timing analysis according to one embodiment. As shown, a timing information determiner 102, a delay calculator 104, and a timing analyzer 106 are provided.

Timing information determiner 102 is configured to determine timing information that can be used to perform the timing analysis. The timing information may be included in a model for cells that may be included in a layout of an integrated circuit design. For example, timing values may be included in timing files, such as .lib files, for a library of cells. A library may be any set of information for elements of a design realization of an integrated circuit. The library may include a collection of cells, macros or functional units that perform common operations and are used to build more complex logic blocks. For example, the library may include standard cells, memory, analog components, input/output (I/O), low level logic functions (AND, OR, INVERT, flip-flops, latches and buffers), etc. The cells may be models of devices in the design. The timing information for cells may be electrical properties (timing and power parameters) of the instances that compose the design. Also, timing information may be provided for interconnects. For example, resistance and capacitance values may be determined for interconnects between cells.

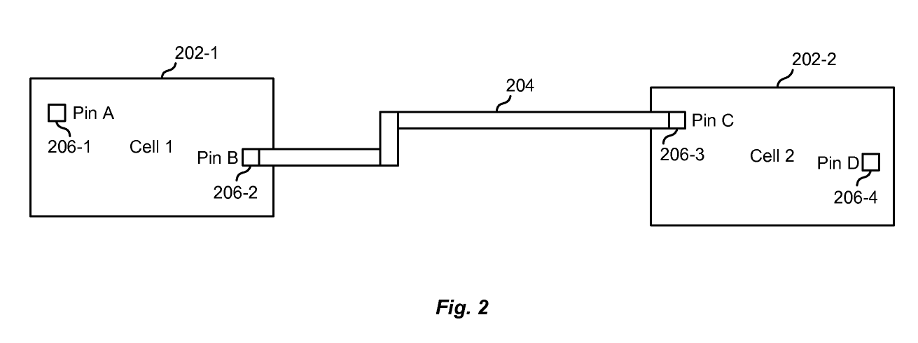

Timing can be measured intrinsically within a cell and through the interconnect between cells. FIG. 2 shows an example of a layout for an integrated circuit design that shows where timing can be measured according to one embodiment. As shown, a cell 202-1 and a cell 202-2 are connected with an interconnect 204. Input and output pins 206 are also provided for cells 202. In this example, timing may be measured from pin 206-1 (pin A) to pin 206-4 (pin D). In this case, timing may be measured internally in cells 202 and also externally through interconnect 204. Thus, different timing values may be determined between pin 206-1 and pin 206-2, pin 206-2 to pin 206-3, and pin 206-3 to pin 206-4.

The timing information for cells 202 may be stored in timing files, such as .lib files. Although .lib files are described, it will be understood that .lib files may be any files that include timing information for cells 202. Cells 202 may represent different instances in the integrated circuit design, such as inverters, n-type metal-oxide-semiconductor field effect transistors (N-MOSFETs), PMOSFETS, etc. Different cells 202 may have different timing information. For example, an inverter may have timing information in a first timing file and a NMOS transistor may have timing information in a second timing file.

The timing information for interconnect 204 may be included in a parasitic interconnect file, such as a .rspf (reduced standard parasitic format) file or .spef (standard parasitic exchange format) file, which gives resistance and capacitance values for interconnect 204. These values may be used in performing the timing analysis.

Referring back to FIG. 1, delay calculator 104 receives the timing information and can determine a delay that may occur between pin 206-1-pin 206-2, pin 206-2-pin 206-3, and pin 206-3-pin 206-4 of FIG. 2. For example, a delay format file, such as a .sdf (standard delay format) file, is outputted that includes the cell delay description and the interconnect delay description. The cell delay description describes the signal transmission delay data intrinsically in cell 202 and the interconnect delay description describes the signal transmission delay data on interconnect 204 between the cells.

Timing analyzer 106 is then configured to generate timing reports. Timing analyzer 106 may be a static timing analysis (STA) tool and/or a spice simulator. The timing analysis determines that the integrated circuit design can be operated at a specific clock frequency without errors caused by signals arriving too soon or too late. Clock transitions may be simulated to determine if any timing violations occur. For example, any timing violations that may occur from pin 206-1 to pin 206-4 may be determined. A person skilled in the art will appreciate how a timing analysis may be performed.

### Context Dependent Timing Analysis and Prediction Overview

During fabrication of integrated circuits, contouring of features may occur. For example, contouring of critical dimensions, such as a gate, interconnect, or other areas that are electrically sensitive to process variations, may occur. The contouring may result based on process variation factors, which may be any information that models process variations that may occur in the photolithographic process. As mentioned above, the desired IC features are generally smaller than the wavelength of the light used for lithographic patterning and the layout does not print as drawn. Corners become rounded, line ends pull back, line widths change, and straight lines can now have ripples. The effects of changes in the feature shapes may be referred to as “contouring”.

The contouring may affect the delay that results between pins 206-1 and 206-4. Thus, if drawn data is used to determine timing information, a timing analysis may not be accurate for the integrated circuit design. Accordingly, particular embodiments characterize timing information to take into account contouring that may result during a fabrication process. This provides a better timing analysis.

A simulator may be used to generate a contoured representation of the layout. However, the contouring that may result may be different depending on the different context situations in the design. For example, different contouring of features may occur based on different context situations. In an integrated circuit layout, the area around a cell may affect the behavior of the cell. For example, having different neighboring cells affects the contouring that results and consequently the timing information for cells should reflect the contouring for an accurate timing analysis.

In one embodiment, a cell may be context independent or context dependent. A cell may be context independent when there are not substantial conditions that affect the cell. For example, filler cells with dummy poly within the cell may be placed outside a cell. This isolates the cell from any process variations that may result from neighboring cells. In this case, the timing information, such as a timing file, is characterized using possible contouring that may result without taking into account external factors (context).

A cell may also be context dependent. In this case, cells around a cell may affect the behavior of a cell. Thus, the context situation for the cell needs to be taken into account when determining the contour. The contouring determined for a cell is then used to characterize the timing information for that cell. However, a design may have many different context situations for a cell. For example, an inverter may be used ten times in a design. Conventionally, a standard library of cells would have one timing file for the inverter that can be used ten times. However, each instance of the inverter may be placed next to different cells in the design; thus resulting in a different context situation for each instance. This results in a different behavior for each instance. Accordingly, the timing may need to be characterized differently for each inverter based on the different context situations.

Calculating the characterization based on the context situation during the timing analysis may be computationally extensive. The characterization may involve enhancing or re-characterizing timing files for instances in the design. Accordingly, particular embodiments pre-compute timing information for a library based on possible context situations that may result. Then, a look-up of the timing information when a context situation occurs can be performed when the timing analysis is run. Thus, the characterization of the timing information based on the context situation does not need to be calculated during run time. This may provides a fast simulation. Also, this does not change the flow for performing a timing analysis as a lookup of the timing file is still performed but the characterization is not performed during runtime. In one embodiment, the pre-computation may be a process where an input is a library and the output is re-characterized timing information for the library. In one embodiment, during runtime, the input may be a portion of a layout and the output is a timing analysis. During runtime, a lookup of the re-characterized timing information is performed by re-characterization is not performed during runtime in one embodiment.

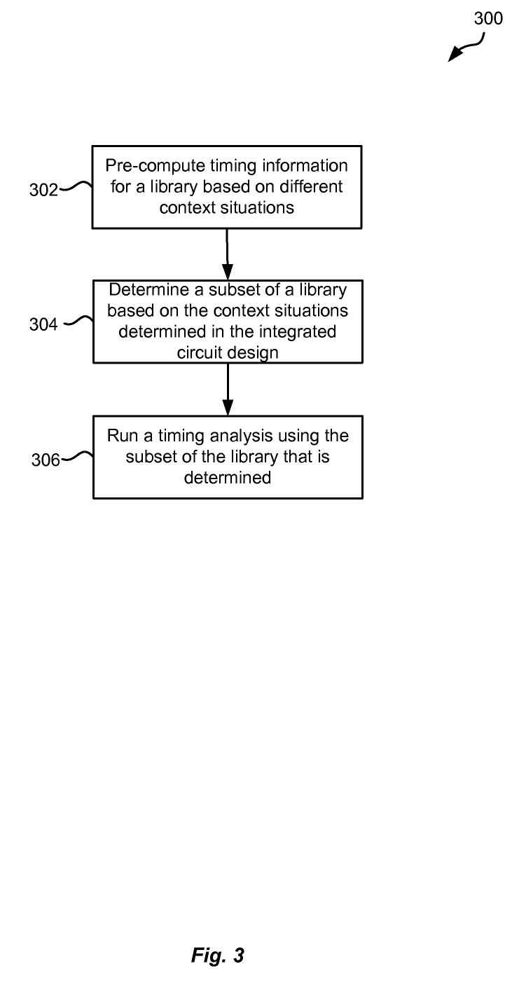

An overview of the timing analysis will now be described. FIG. 3 depicts a simplified flowchart 300 of a method for determining a library to use for the timing analysis according to one embodiment. Step 302 pre-computes timing information for a library based on different context situations. The pre-computation takes into account different context situations that may occur in the integrated circuit design.

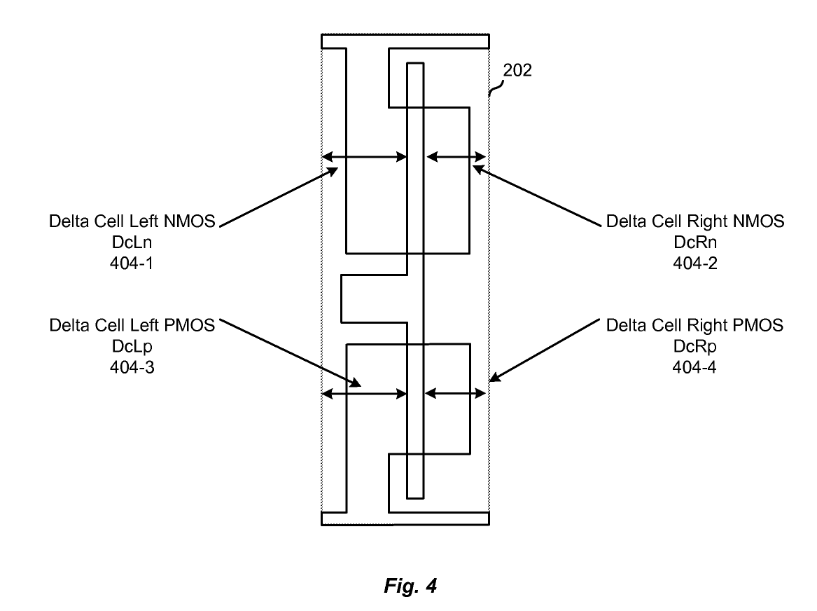

FIG. 4 depicts an example of a cell 202 according to one embodiment. Context parameters may be provided in cell 202. For example, four context parameters 404-1-404-4 are provided. Although four parameters are described, it will be understood that any number of parameters may be used. In one example, parameter 404-1 corresponds to a delta cell left for an NMOS transistor, parameter 404-2 corresponds to a delta cell right for an NMOS transistor, parameter 404-3 corresponds to a delta cell left for a PMOS transistor, and parameter 404-4 corresponds to a delta cell right for a PMOS transistor. The parameters 404 measure the edge of the polysilicon to a side of the cell border. Although these measurements are described, it will be understood that other measurements may be used, such as other difference information that may vary in the design.

Parameters 404 are used to determine the context situation for a cell. For example, when cell 202 is placed next to other cells, parameters 404 for the other cells are used to characterize timing information for the cell. Because parameters 404 may differ for different cells, different context situations may result. Thus, the timing information for a cell may be characterized depending on the parameters 404 of cell 202.

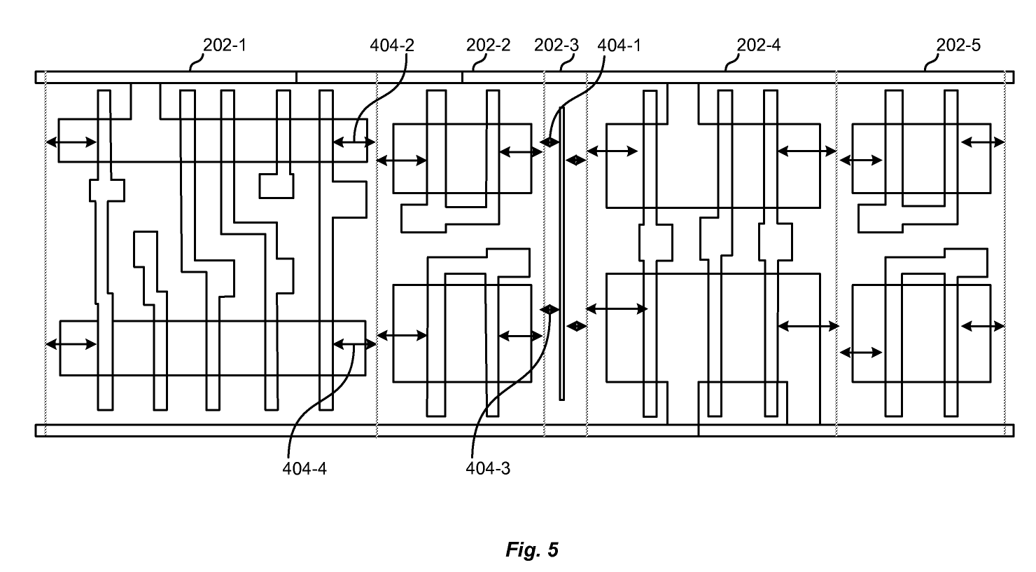

As discussed above, different context situations may result in a design. FIG. 5 shows an example of a place and route for an integrated circuit design 500 according to one embodiment. As shown, four cells 202-1-202-4 are provided.

Different context situations may result based on the context parameters of neighboring cells 202. For example, for cell 202-2, a context parameter 404-2 and a context parameter 404-4 of cell 202-1 may affect the timing information for cell 202-2. Further, a context parameter 404-1 and a context parameter 404-3 for cell 202-3 may affect the timing information for cell 202-2. Thus, the external context parameters for a cell may be determined. These parameters are then used to characterize the timing information for a cell 202. Although these external context parameters are described, it will be understood that other parameters may be used. For example, internal parameters may also be used to determine the context situation.

As can be seen in FIG. 5, different context situations occur based on the context parameters of neighboring cells 202. For example, cell 202-4 has a different context situation based on cells 202-3 and 202-5 next to it than cell 202-2, which has cells 202-1 and 202-3 next to it. Accordingly, these different context situations need to be taken into account in determining timing information. When the full chip design is taken into account instead of the place and route shown in FIG. 5, many different variations may occur. For example, a cell 202-2 may be placed in multiple locations in the design. In another location, instead of having cell 202-3 next to cell 202-2, cell 202-4 may be placed next to cell 202-2. In this case, the context situation is different as context parameters 404-1 and 404-3 are different for cell 202-4 than for cell 202-3. Thus, the timing information may be characterized differently for this context situation because the contouring that may result may be different. Thus, the same cell will have different context situations that cause different characterizations of timing information.

Accordingly, step 302 determines different context situations that are possible. For example, all possible context parameters for each cell 202 within a library may be determined. Thus, each different context situation for an individual cell may be determined. This may be performed for all cells in a standard library. For example, a standard library may have timing files for instances in the design. The timing files for these instances are re-characterized based on the different possible context situations. Although every single combination for the context parameters is determined, it will be understood that not all the combinations may be determined. For example, the process may be optimized and only certain numbers of context parameters may be used. The optimization process will be described in more detail below.

Thus, each cell is characterized for each possible context situation that may result. This ensures that no matter which context situation occurs, timing information for a cell will have been characterized for that context situation. For example, if in a layout, it is determined that four unique context situations can occur with a cell 202, then the characterized timing information has already been pre-computed for those four unique situations. In this case, four timing files may be created, one for each context situation. Each timing file includes characterized timing information based on the context parameters associated with the context situation.

Because the library now includes timing files for all context situations, only a certain number may occur in the design. Step 304 determines a subset of a library based on the context situations determined in the integrated circuit design. The integrated circuit design may be searched to determine the context situations that result. Then, the timing information for cells based on the context situations is determined. For example, a timing file for the context situation is determined. In the design, it is expected that not all the context situations may have resulted; thus, a subset of the library is determined based on the context situations that result.

Step 306 then runs a timing analysis using the subset of the library that is determined. For example, the subset of timing files is used to run the timing analysis. It should be noted that some timing files may not have been characterized for context situations because they may be context independent. Also, timing information for the interconnect may also be determined and used in the timing analysis. The timing information for the interconnect may be characterized based on contouring that may result. The characterization may be performed full chip or only in areas of interest. Accordingly, a context aware timing analysis performed.

### Library Pre-Computation

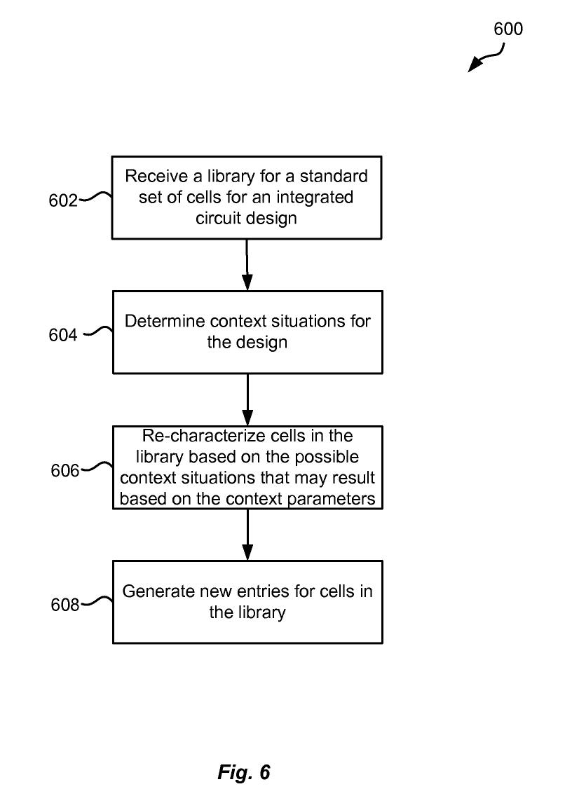

As mentioned above, the pre-computation of the library is performed based on possible context situations that occur. FIG. 6 depicts a simplified flowchart 600 of a method for performing the pre-computation according to one embodiment. Step 602 receives a library for a standard set of cells for an integrated circuit design. The standard set of cells may include timing information in the form of timing files that do not take into account contouring due to processing variations.

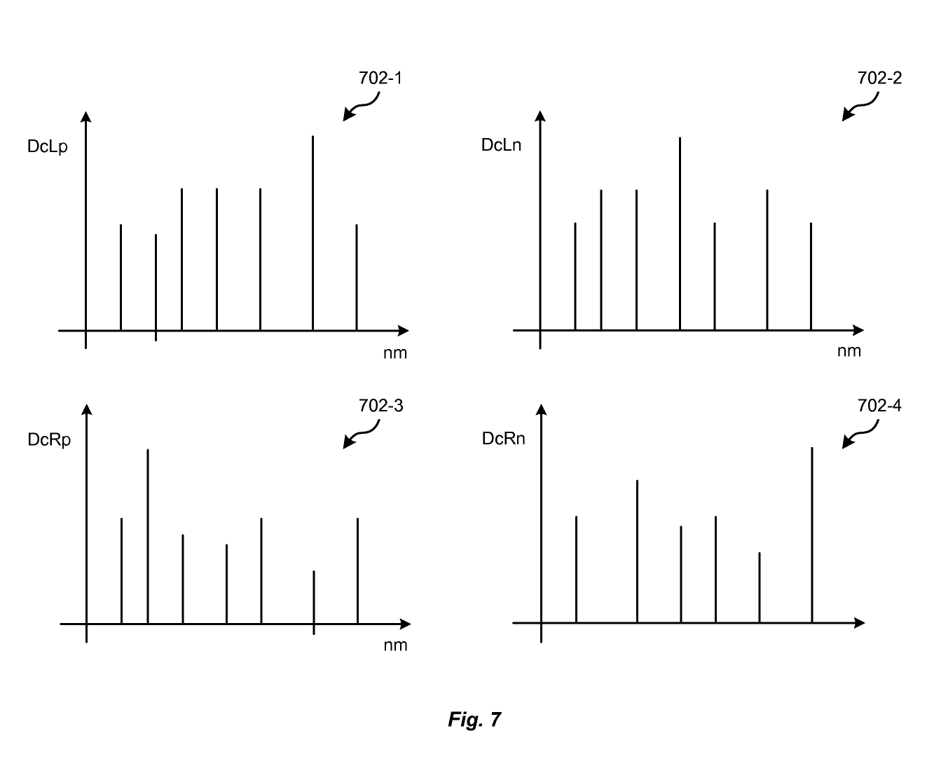

Step 604 determines context situations for the design. For example, it is possible to determine the different context parameters that may result for the library. FIG. 7 shows a distribution for context parameters for four parameters according to one embodiment. As shown, different values may result based on the parameters for each cell 202 in the library. In a distribution 702-1, the different lengths for context parameter 404-1 are shown. In this case, seven different delta values for the delta cell left PMOS are shown. That is, for all the cells in the library, these are the delta values that may result from delta cell left PMOS. Although seven values are shown, it will be understood that any number of values may be used. Thus, using the distribution, if any cell is placed next to a target cell, then one of these delta values will be in the cell next to the target cell. The distribution may be determined for each context parameter 202. As shown, different distributions 702 are provided for each context parameter 202. Different context situations are then determined based on distributions 702.

Step 606 then characterizes cells in the library based on the possible context situations that may result. For example, each context situation includes a unique combination of context parameters 404. For each context situation, the timing information for a cell is characterized based on the unique combination of context parameters 202.

In one example, a timing file is characterized based on a combination of context parameters 704-1, 704-2, 704-3, and 704-4. This is a first context situation. Also, the same timing file may be characterized based on context parameters 704-5, 704-2, 704-3, and 704-4. This yields a second timing file. This process continues until each possible combination for the distribution of context parameters 202 is determined. Although all possible context combinations may be determined, it will be understood that an optimization process may be used such that not all the context situations may be determined and used to characterize the timing information for a cell. This process will be described in more detail below.

Step 608 then generates a re-characterized library for the cells in the library. The re-characterization may be represented in many ways. For example, a cell library may be rewritten to include additional timing files based on the re-characterization. A timing file is then created for a characterization of the timing information for the unique combination of context parameters. New timing files are created for each context situation for a cell. Thus, a library may have the original standard cell of timing information (without taking into account processing variations) and an additional timing file for each context situation. Also, timing information may be added to the library. For example, timing information for the re-characterization may be added to the library or used to enhance information in the library.

The library of timing files is pre-computed and characterization of timing information during run time of the timing analysis does not need to occur. Rather, the timing information for a context situation that results during timing analysis needs to be retrieved from the library that includes the new entries. A subset of the library is most likely determined because all the context situations are included in the library.

### Library Determination During Runtime

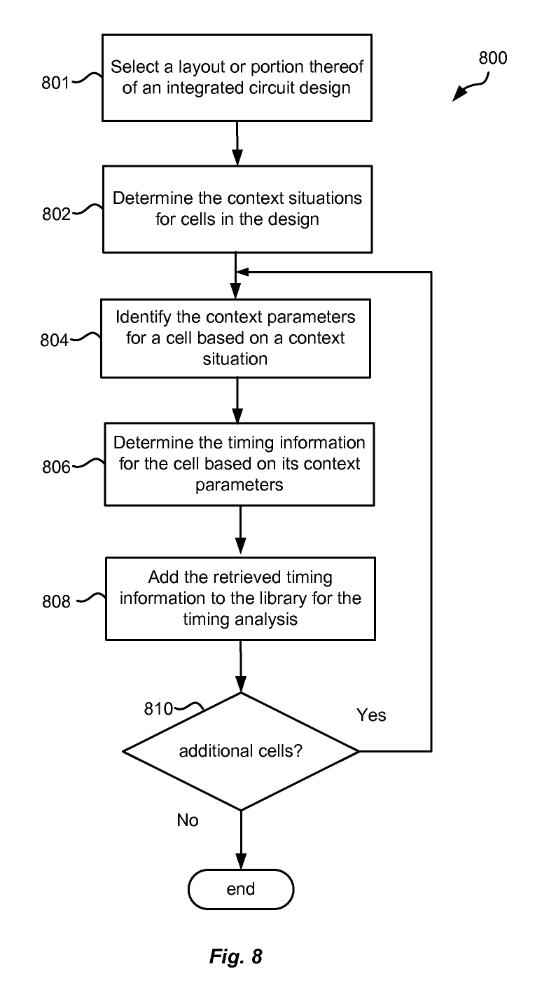

FIG. 8 depicts a simplified flowchart 800 of a method for determining a subset of the library for a timing analysis according to one embodiment. Step 801 selects a layout or portion thereof of an integrated circuit design. For example the layout may be part of a place and route using cells of a library.

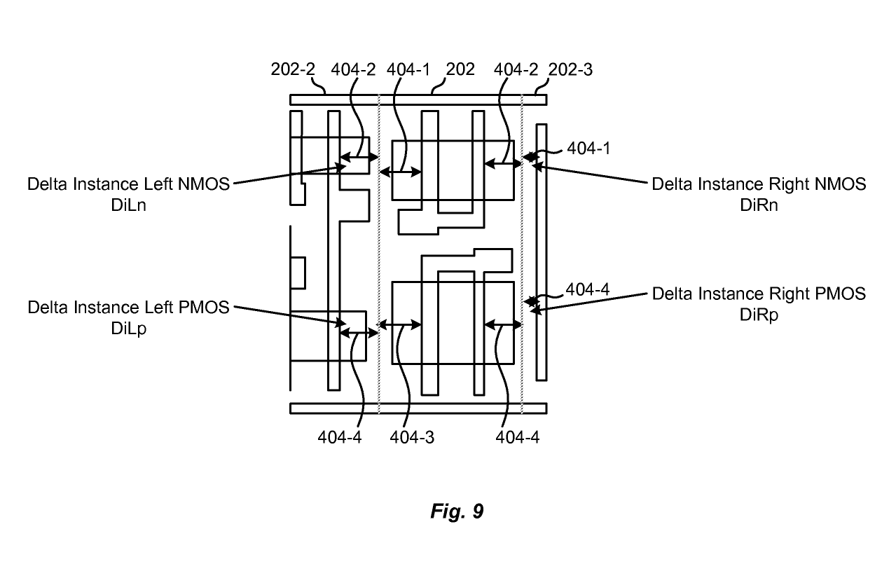

Step 802 determines the context situations for cells in the layout. FIG. 9 shows the example of a context situation that can be determined. As shown, a cell 202 includes four internal context parameters 404-1-404-4 and four external context parameters 404-1, 404-2, 404-3, and 404-4. These correspond to the delta instance values as described in FIG. 2. As shown, context parameters 404-2 and 404-4 of cell 202-2 and context parameters 404-1 and 404-4 of cell 202-3 form the external parameters. For each cell 202 in an integrated circuit design, the context parameters are determined.

The process then determines the timing information for the context situations. Step 804 identifies the context parameters for a cell 202 based on a context situation.

Step 806 then determines the timing information for the cell based on its context parameters. For example, a timing file is retrieved based on the four external context parameters 404 for the cell (a context situation). The timing files were pre-computed in the pre-computation stage for all possible context situations and thus a timing file for the context situation has been pre-computed and is retrieved. For example, a table lookup may be used to determine the correct timing file for the context situation. In one example, timing files may be indexed by the context situations. The parameters may be used to determine the context situation in the table and a corresponding timing is retrieved.

Step 808 then adds the retrieved timing information to the library for the timing analysis. Thus, a subset of the library is being determined for the timing analysis.

Step 810 determines if additional cells need to be processed. If so, the process reiterates to step 804 where the context situation for another cell is determined and the timing information based on the context situation is retrieved and added to the library.

If additional cells do not need to be processed, step 812 outputs the library for timing analysis. The library provided includes a subset of the timing files that were pre-computed. The library includes timing information that has been characterized based on the context situations that may occur in the design.

The retrieval of the timing information based on the context situation may be very fast. Thus, when performing a timing analysis, the retrieval does not significantly slow down the timing analysis calculation. In one embodiment, a table may be used to look up the timing file from the pre-computed library. This is much faster than determining the context situation and re-characterizing the cell based on the context parameters that result. Rather, the characterization has already been pre-determined and the correct timing file just needs to be retrieved.

Further, the timing analysis methodology does not need to be significantly changed using particular embodiments. Rather, delay calculator 104 can provide a delay format file using the timing files and timing analyzer 106 uses the delay format file to perform the timing analysis. However, this library has been characterized based on the context situations that have occurred. This is different from having a process flow characterize timing files while the timing analysis is being performed. In this case, a look-up of the timing files just needs to be performed.

Also, the characterization is just done once in the pre-computation stage. Thus, the characterization does not need to be performed each time the timing analysis is performed. This saves time and computational resources.

A histogram of context situations as well as timing information may be outputted. This histogram may be displayed to a user to allow the user to determine the variability of a layout or cell. For example, a design may have many different context situations that are not clustered together, which may indicate that the design may be harder to manufacture. However, if the histogram indicates context situations that are clustered together, then the design may be easier to manufacture.

### Optimization

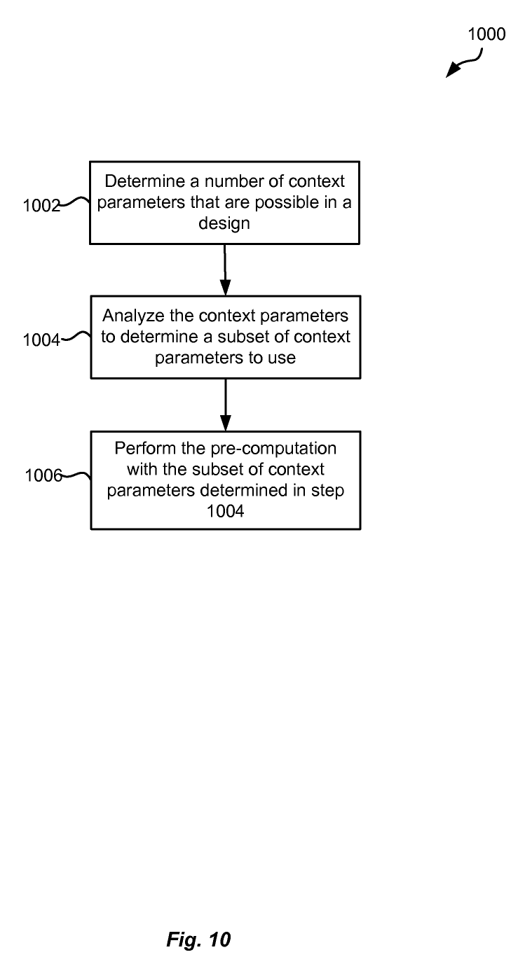

The number of context situations that may result for characterization may be large depending on the number of potential context parameters that may be present within a library. However, since the pre-computation is performed only once, the computational time spent to characterize timing information is minimized. However, even so, particular embodiments may optimize the number of context situations that may be used. FIG. 10 depicts a simplified flowchart 1000 of a method of optimizing the pre-computation according to one embodiment. Step 1002 determines a number of context parameters 404 that are possible in a design.

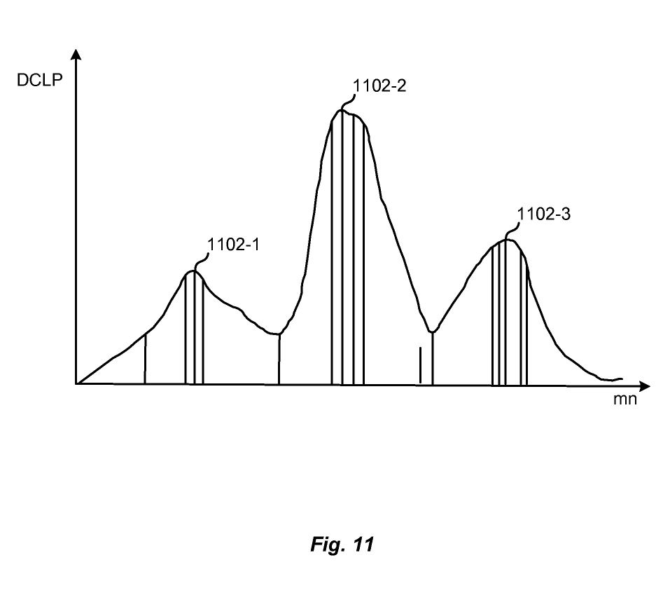

Step 1004 analyzes the context parameters to determine a subset of context parameters to use. In one example, if the context parameters are closely situated in a certain distribution or may occur more often, then those may be candidates to be used. For example, FIG. 11 shows a possible distribution for a context parameter. This distribution shows three clusters 1102-1, 1102-2, and 1102-3. In this case, the delta parameters have values that are around clusters 1102-1, 1102-2, and 1102-3. Thus, context parameters for these points 1102 may be used instead of the large number of points that make up the distribution. Thus, although not all context situations may be determined, it will be expected that one of these context parameters may be close to a context parameter that may result and thus a pre-computed characterization based on a context situation that is close to the context situation may be appropriate.

Step 1006 then performs the pre-computation with the subset of context parameters determined in step 1004. The timing analysis can then be performed as described above.

### CONCLUSION

Although the description has been described with respect to particular embodiments thereof, these particular embodiments are merely illustrative, and not restrictive. Although particular embodiments are described with respect to the creation of integrated circuits, it will be appreciated that the techniques of particular embodiments may be applied to any manufacturing process that is subject to process variations. Examples of processes include, but are not limited to, mask bias, overlay errors, film stack thickness variations, mask phase errors, post-exposure bake temperatures, resist development times and post exposure bake times. Other devices fabricated lithographically where particular embodiments may be applied may include Micro-electromechanical systems (MEMS), magnetic heads for disk drives, photonic devices, diffractive optical elements, nanochannels for transporting biological molecules, etc.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope , as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for characterizing instances in an integrated circuit design, the method comprising:
determining a plurality of context situations for instances in at least a portion of a layout for the integrated circuit design;
characterizing timing information for the instances based on the context situations for the instances, wherein the timing information for each instance is characterized based on process variations that may result based on the context situation for each instance, wherein a characterization for each of the plurality of context situations is generated; and
storing the characterization for each of the plurality of context situations.

2. The method of claim 1, wherein a context situation comprises a unique combination of context parameters determined for an instance in the plurality of instances.

3. The method of claim 2, wherein the context parameters are parameters determined from external instances external to the instance.

4. The method of claim 3, wherein the context parameters comprise delta parameters measured in the external instances.

5. The method of claim 1, wherein the characterizing is performed before runtime of a timing analysis tool such that the characterization may be retrieved from the library rather than be computed during runtime.

6. The method of claim 1, wherein determining the plurality of context situations comprises:
determining a plurality of parameters for the instances in the at least a portion of the layout; and
determining the plurality of context situations based on unique combinations of the plurality of parameters.

7. The method of claim 6, further comprising:
optimizing the plurality of parameters used by selecting a subset of the plurality of parameters; and
determining the plurality of context situations based on the subset of the plurality of parameters.

8. The method of claim 1, wherein the instances comprise cells or interconnects in the design.

9. The method of claim 1, wherein the characterization for each of the plurality of context situations is stored in a library, the library including one or more timing files for one or more instances that are characterized based on the context situation.

10. A method for characterizing an instance in an integrated circuit design for a timing analysis, the method comprising:
identifying a context situation for the instance in at least a portion of a layout for the integrated circuit design;
determining a characterization for the instance based on the context situation from pre-computed characterizations that are pre-computed based on combinations of context situations that may be found in the at least a portion of the layout, the determined characterization including timing information that is characterized based on process variations that may result based on the context situation; and
providing the determined characterization for the timing analysis.

11. The method of claim 10, wherein the context situation uniquely identifies the characterization for the instance, wherein determining the characterization comprises using the context situation for the instance to retrieve the instance from the pre-computed characterizations.

12. The method of claim 10, wherein a context situation comprises a unique combination of context parameters determined for an instance in the plurality of instances.

13. The method of claim 12, wherein the context parameters are parameters determined from external instances external to the instance.

14. The method of claim 13, wherein the context parameters comprise delta parameters measured in the external instances.

15. The method of claim 10, wherein the characterization comprises cells or interconnects in the design.

16. The method of claim 10, wherein the characterization for the instance is stored in a library, the library including a timing file for the instance that is characterized based on the context situation.

17. Software encoded in one or more computer-readable media for execution by the one or more processors and when executed operable to:
determine a plurality of context situations for instances in at least a portion of a layout for an integrated circuit design;
characterize timing information for the instances based on the context situations for the instances, wherein the timing information for each instance is characterized based on process variations that may result based on the context situation for each instance, wherein a characterization for each of the plurality of context situations is generated; and
store the characterization for each of the plurality of context situations.

18. The software of claim 17, wherein a context situation comprises a unique combination of context parameters determined for an instance in the plurality of instances.

19. The software of claim 18, wherein the context parameters are parameters determined from external instances external to the instance.

20. The software of claim 19, wherein the context parameters comprise delta parameters measured in the external instances.

21. The software of claim 17, wherein the software operable to characterize is performed before runtime of a timing analysis tool such that the characterization may be retrieved from the library rather than be computed during runtime.

22. The software of claim 17, wherein the software operable to determine the plurality of context situations comprises software that, when executed, is further operable to:
determine a plurality of parameters for the instances in the at least a portion of the layout; and
determine the plurality of context situations based on unique combinations of the plurality of parameters.

23. The software of claim 22, further comprising software that, when executed, is further operable to:
optimize the plurality of parameters used by selecting a subset of the plurality of parameters; and
determine the plurality of context situations based on the subset of the plurality of parameters.

24. The software of claim 17, wherein the instances comprise cells or interconnects in the design.

25. The software of claim 17, wherein the characterization for each of the plurality of context situations is stored in a library, the library including one or more timing files for one or more instances that are characterized based on the context situation.

26. Software encoded in one or more computer-readable media for execution by the one or more processors and when executed operable to:
identify a context situation for an instance in at least a portion of a layout for an integrated circuit design;
determine a characterization for the instance based on the context situation from pre-computed characterizations that are pre-computed based on combinations of context situations that may be found in the at least a portion of the layout, the determined characterization including timing information that is characterized based on process variations that may result based on the context situation; and
provide the determined characterization for the timing analysis.

27. The software of claim 26, wherein the context situation uniquely identifies the characterization for the instance, wherein determining the characterization comprises using the context situation for the instance to retrieve the instance from the pre-computed characterizations.

28. The software of claim 26, wherein a context situation comprises a unique combination of context parameters determined for an instance in the plurality of instances.

29. The software of claim 28, wherein the context parameters are parameters determined from external instances external to the instance.

30. The software of claim 29, wherein the context parameters comprise delta parameters measured in the external instances.

31. The software of claim 26, wherein the characterization comprises cells or interconnects in the design.

32. The software of claim 26, wherein the characterization for the instance is stored in a library, the library including a timing file for the instance that is characterized based on the context situation.
